(19) United States
(12) Patent Application Publication
(10) Pub. No.: US 2025/0280754 A1
(43) Pub. Date: Sep. 11, 2025

(54) INDEPENDENTLY FUNCTIONING CLOSING WHEEL ARMS EACH WITH VARIABLE DOWN FORCE ADJUSTMENT FOR AN AGRICULTURAL ROW UNIT CLOSING ASSEMBLY

(71) Applicant: Matthew Hornung, Dodge City, KS (US)

(72) Inventor: Matthew Hornung, Dodge City, KS (US)

(21) Appl. No.: 18/596,856

(22) Filed: Mar. 6, 2024

(51) Int. Cl. A01C 5/06; A01B 49/02; A01B 61/04; A01B 63/26; A01B 63/30; A01B 63/32

(52) U.S. Cl. CPC A01C 5/066; A01B 49/027; A01B 61/046; A01B 63/26; A01B 63/30; A01B 63/32; A01C 5/068

(57) ABSTRACT

A closing assembly for an agricultural row unit to be mounted on a trenching implement and configured for trench closing functions of various seeding, fertilizer, soil amendments, and soil working purposes. An example of the closing assembly includes a mounting frame for attaching to the agricultural row unit of the trenching implement. At least one mounting arm having a first end is connected to pivot about a mounting axis on the mounting frame, and a second end movable to different heights in response to pivotable movement of the first end. A handle is operatively associated with the mounting arm and moveable between at least two separate positions corresponding to the different heights of the second end of the mounting arm. At least one closing wheel is rotatably mounted on the second end of the mounting arm to move between each of the different heights.

### BACKGROUND

Planting equipment has long been used for planting seeds such as row and cereal crops. Typically planting seeds is accomplished by means of a row crop planter and a grain drill or air seeder. The forgoing will briefly describe typical arrangements of each.

A row crop planter commonly refers to seeders with the capability of singulating seeds for each opener unit's placement, and typically with a relatively wide spacing between individual opener units. A typically row crop planter opener unit includes one or more seed singulating devices and opening discs for creating a V-shaped slot in the soil for seed placement. Gauge wheels running along the side of the opening discs on the planter determine the maximum planting depth and scrape the outside surface of the discs to keep wet soil from building up on the disc. Separate closing wheels behind the opening disks are responsible for closing the V-shaped slot in the soil after the seeds have been placed therein.

A grain drill or air seeder commonly refers to a seeder lacking the capability of equally spaced seed singulation and seeds at higher rates than that of a row crop planter. In a grain drill configuration, seed is volumetrically metered from a hopper box above the furrow opener utilizing gravity to deliver the seed to the seed trench. Alternatively, a grain drill air seeder refers to a centralized hopper that volumetrically meters seed and then utilizes a fan to blow seed out to each opener unit and into the trench.

Grain drills and air seeders tend to have the opener units mounted to achieve narrow row spacing, although the openers may be mounted in a staggered pattern of two or more ranks on a single or multiple toolbars. Drill or seeder opener units are manufactured employing a wide variety of furrow openers, including non-rolling shank style openers, and both single-and double-disc openers. These openers typically gauge their depth and close the seed trench from packer or press wheels that operate rearward of the shank or disc blades. Separate disc scrapers are mounted to the opener for removing wet or tight soil from the disc blades and improving soil trench cutting and forming.

Some disc-openers also gauge their depth by using a gauge wheel alongside the opener and separate wheel or wheels for closing the seed trench. One issue with this style of opener is adequate clearance to the adjacent row to allow high residue and straw to move through the system in a narrow spacing drill configuration. Narrow spacing with this type of opener is accomplished by staggering the openers or mounting on two different ranks to allow material to flow through. With this type of configuration turning and contouring with the openers in the ground is greatly restricted due to the overlapping of the adjacent forward row from the reward row. Additionally side load and wear is greatly increased due to this staggered double rank configuration.

### BRIEF DESCRIPTION OF THE DRAWINGS

FIG. 1 depicts a perspective view of an example of independently functioning closing wheel arms each with variable down force adjustment on an agricultural row unit closing assembly.

FIG. 2 depicts a top perspective view of the example independently functioning closing wheel arms on an agricultural row unit closing assembly corresponding to FIG. 1.

FIG. 3 depicts a front perspective view of the example independently functioning closing wheel arms corresponding to FIG. 1, without the agricultural row unit closing assembly.

FIG. 4 depicts a top view of the example independently functioning closing wheel arms corresponding to FIG. 3.

FIG. 5 depicts a bottom view of the example independently functioning closing wheel arms corresponding to FIG. 3.

FIG. 6 depicts a side view of the example independently functioning closing wheel arms corresponding to FIG. 3.

FIG. 7 depicts a side perspective view of the example independently functioning closing wheel arms corresponding to FIG. 3.

FIG. 8 depicts a right side view of another example of independently functioning closing wheel arms having a third independent wheel assembly on an agricultural row unit closing assembly.

FIG. 9 depicts a left side view of the example of independently functioning closing wheel arms with the third independent wheel assembly on an agricultural row unit closing assembly, corresponding to FIG. 8.

### DETAILED DESCRIPTION

An agricultural implement is disclosed as it may utilize a multi-functional wheel or wheels that provide a row unit adjustable depth function and seed trench closing function.

In an example, an agricultural planter with seed trencher disc(s) and seed delivery mechanism deposits seeds (or other product) in the trench opened by the disc(s). Multi-functional or closing wheels are mounted rearward of the trencher disc(s) on an adjustable arm so as to provide a depth gauging function for the trencher discs. The wheels are mounted to run at an angle and distance corresponding to the disc blades, so as to move displaced trench soil back over the trench while effectively running at a position where dirt and debris try to lift out of the opening trench due to the action of the disc cutting blades. This allows the wheels to apply pressure in the lift out zone area of dirt and debris as to prevent the lift out from occurring. The wheels have optional fingers arrayed around the wheel rim to further prevent soil lift out and aid in movement of crop debris and residue through the system while reducing the soil to a fine homogenous soil for an optimal planting condition. Furthermore, this wheel configuration allows for narrow spacing of adjacent seeder devices while keeping crop debris residue from building up between devices and plugging.

A trenching device includes a trench opener disc. The closing wheel is coupled to the trench opener disc to close the trench opened by the trench opener disc. In an example, the closing wheel also provides one or more depth gauging functions for the trench opener disc, hence the “multi-functional” aspect of the wheel. The trenching device can also include a cleaner function to scrape dirt and residue from the trench opener disc.

In an example, a closing assembly for the closing wheel(s) of an agricultural row unit is disclosed as it can be mounted on a trenching implement and configured for trench closing functions of various seeding, fertilizer, soil amendments, and soil working purposes. An example of the closing assembly includes a mounting frame for attaching to the agricultural row unit of the trenching implement. At least one mounting arm having a first end is connected to pivot about a mounting axis on the mounting frame, and a second end movable to different heights in response to pivotable movement of the first end. An adjustable handle is operatively associated with the mounting arm and moveable between a plurality of positions each corresponding to the different heights of the second end of the mounting arm. At least one closing wheel is rotatably mounted on the second end of the mounting arm to move between each of the different heights.

In an example, the closing wheel is adjustable in a horizontal direction via a horizontal chamber relative to the central plane of the multi-functional wheel, resulting in an increase or decrease of soil over a seed trench.

In an example, the closing wheel is adjustable in a vertical direction and in a pitch angle relative to the central plane of the multi-functional wheel, resulting in an increase or decrease of a movement of soil.

In an example, the trench opener disc is also configured to be adjustable in pitch and camber relative to the central plane of the trench opener disc.

In an example, the closing wheel can include an array of fingers comprising a short length relative to the radius of the wheel. The array of fingers is configured to extend forward of an outer rim of the wheel as the wheel rolls through a lower forward quadrant. The array of fingers is configured to extend outward from the plane of the wheel. The array of fingers is configured to curve and cup, resulting in the array of fingers scooping and moving the soil covering a seed trench.

In an example, each of the array of fingers is configured to extend inwardly of a plane of the wheel, resulting in the soil moving continuously in an outward direction of the wheel, to inwardly fill the seed trench.

Before continuing, it is noted that as used herein, the terms “includes” and “including” mean, but is not limited to, “includes” or “including” and “includes at least” or “including at least.” The term “based on” means “based on” and “based at least in part on.”

It should also be noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

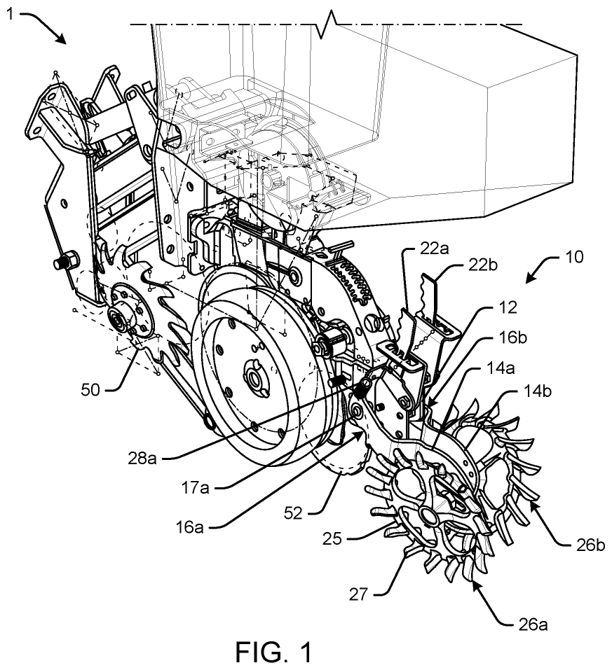

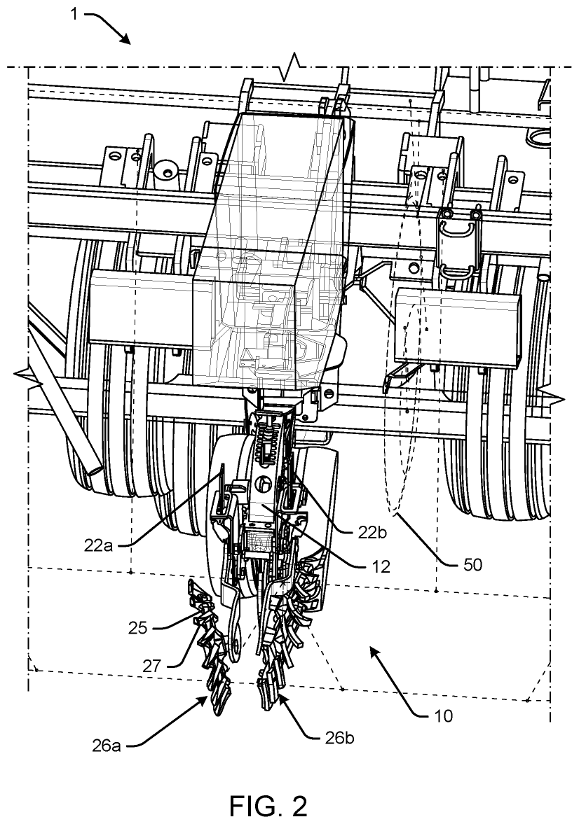

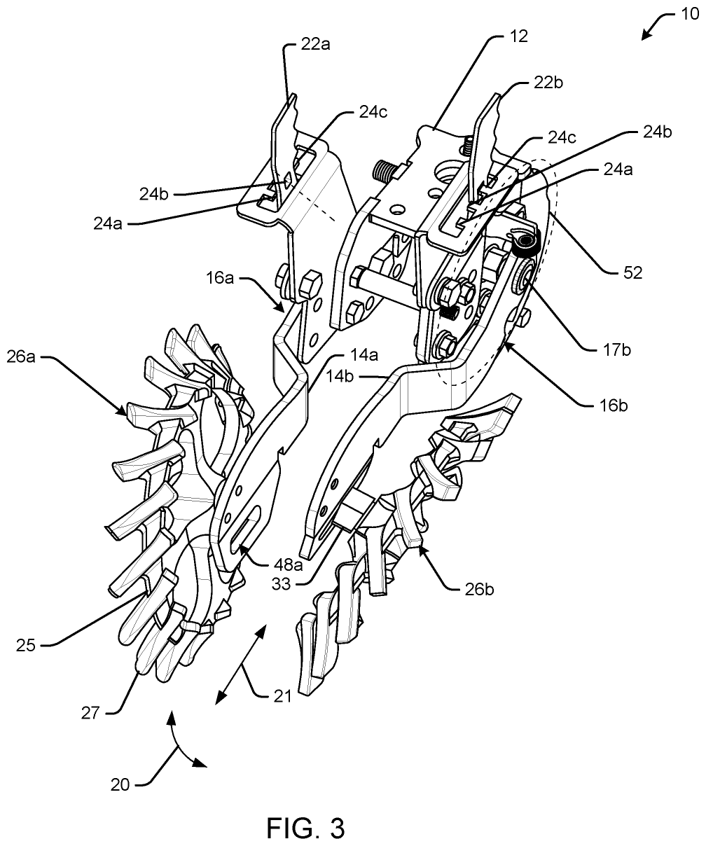

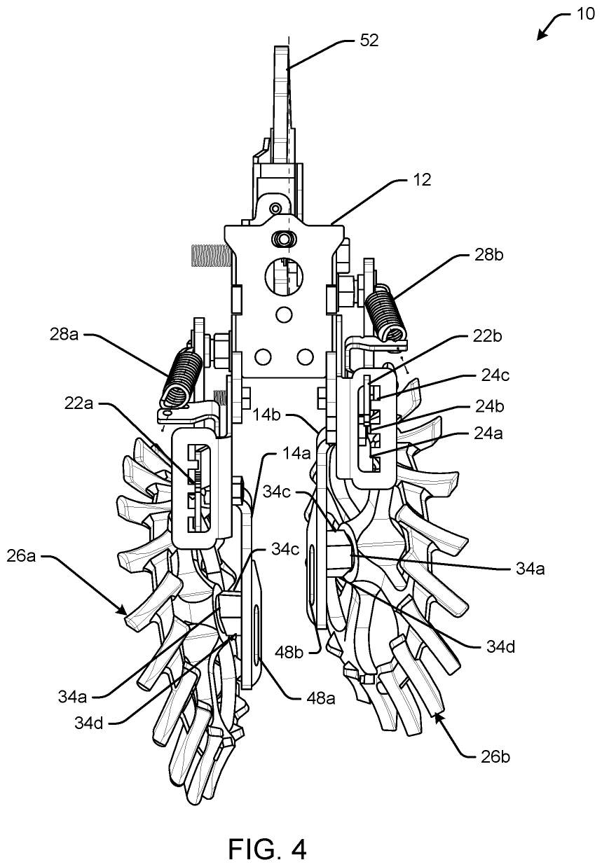

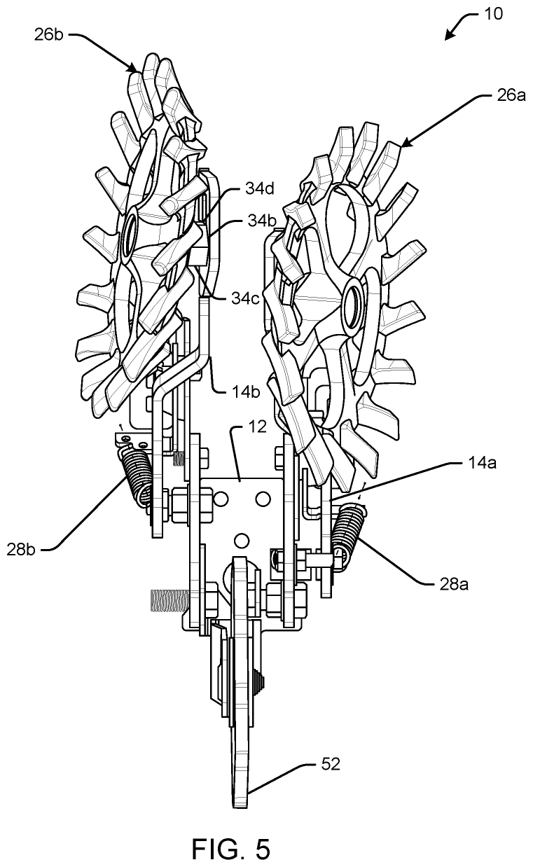

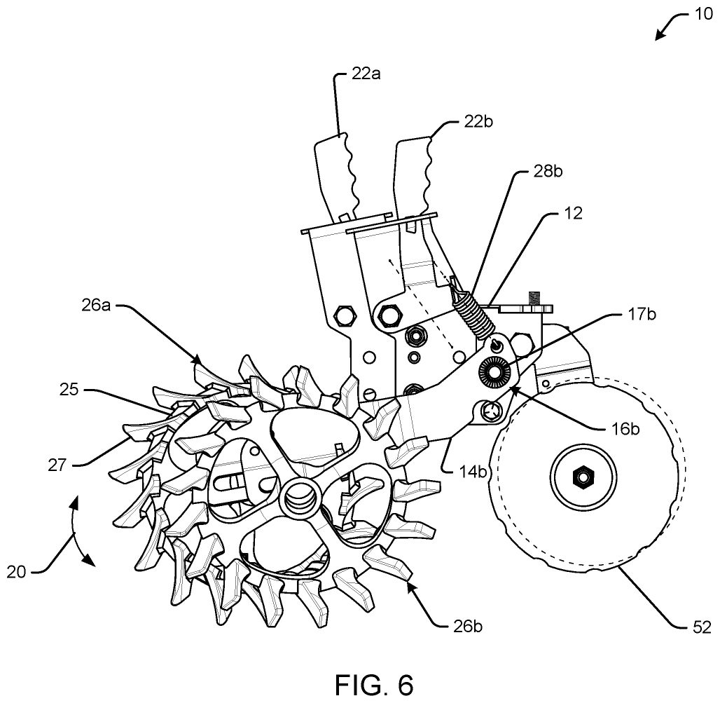

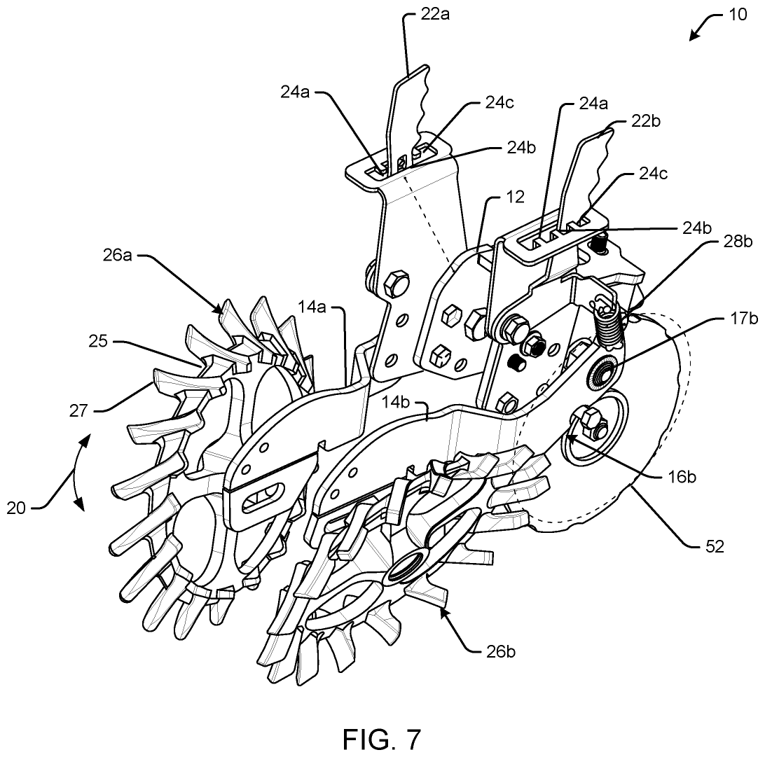

With reference now to FIGS. 1-7, FIG. 1 depicts a perspective view of an example of independently functioning closing wheel arms 10 each with variable down force adjustment on an agricultural row unit closing assembly 1. FIG. 2 depicts a top perspective view of the example independently functioning closing wheel arms 10 on an agricultural row unit closing assembly 1 corresponding to FIG. 1. FIG. 3 depicts a front perspective view of the example independently functioning closing wheel arms 10 corresponding to FIG. 1, without the agricultural row unit closing assembly. FIG. 4 depicts a top view of the example independently functioning closing wheel arms 10 corresponding to FIG. 3. FIG. 5 depicts a bottom view of the example independently functioning closing wheel arms 10 corresponding to FIG. 3. FIG. 6 depicts a side view of the example independently functioning closing wheel arms 10 corresponding to FIG. 3. FIG. 7 depicts a side perspective view of the example independently functioning closing wheel arms 10 corresponding to FIG. 3.

In an example, a closing assembly for an agricultural row unit to be mounted on a trenching implement is configured for trench closing functions of various seeding, fertilizer, soil amendments, and soil working purposes. The closing assembly includes a mounting frame 12 for attaching to the agricultural row unit of the trenching implement, e.g., as illustrated in FIG. 1 and FIG. 2. At least one mounting arm (arms 14a and 14b are shown in the drawings) has a first end 16a, 16b connected to pivot about a mounting axis 17a, 17b on the mounting frame 12, and a second end 18a, 18b movable to different heights (e.g., the movement illustrated by arrows 20 of the second end 18) in response to pivotable movement of the first end about pivot 17a, 17b. In an example, each arm is configured to move independently of the other arm.

In an example, a handle (handles 22a and 22b are shown in the drawings) is operatively associated with the at least one mounting arm (e.g., arms 14a, 14b). The handles 22a, 22b are independently moveable or indexed between a plurality of separate positions 24a-c. Each of the positions 24a-c correspond to different heights of the second end 18 of the corresponding mounting arm 14a, 14b.

It is noted that handles 22a and 22b are not required. In another example, an adjustment device may be provided, such as an automated or partially automated control arm or lever, to perform the function of the handles 22a and 22b. The adjustment device may be operatively associated with the mounting arm (e.g., arms 14a, 14b) and be moveable or indexed between a plurality of separate positions 24a-c. Examples of an adjustment device include, but are not limited to an electric actuator, hydraulic or air cylinder, or air bag.

In an example, at least one closing wheel (two wheels 26a and 26b are shown in the drawings) is mounted on a central axle on the second end 18a, 18b of the mounting arm 14a, 14b to rotate about the axle. The closing wheel 26a, 26b can be moved (e.g., in the direction of arrows 20) along with the second end 18a, 18b of the corresponding mounting arm 14a, 14b between each of the different heights determined by the indexed location 24a-c of the handle 22a, 22b.

In an example, a plurality of indexing positions 24a-c are provided on the mounting frame and fit through the opening or window formed in each handle 22a, 22b. Each of the indexing positions 24a-c are configured by fitting into the window formed in the handle 22a, 22b to retain the handle 22a, 22b at a predetermined position corresponding to desired the height of the wheel 26a, 26b. In the drawings, the three indexing positions 24a-c correspond to three separate positions or heights of the closing wheel 26a, 26b. However, any number of indexing positions corresponding to any desired height(s) of the closing wheel 26a, 26b may be provided.

In the example shown, the two handles 22a, 22b for each of the two mounting arms 14a, 14b are operable to independently move each of the two mounting arms 18a, 18b and corresponding closing wheels 26a, 26b. That is, one of the wheels 26a may be set to the same or different position or height relative to the other wheel 26b. Of course, it is understood that in another example, both of the wheels 26a, 26b may be operated together by a single handle. Likewise, one or more handle can be provided, including more handles than the two handles 22a, 22b shown in the drawings. One or more wheel can be provided, including more wheels than the two wheels 26a, 26b shown in the drawings. In another example, multiple wheels can be mounted to a single mounting arm. These and still other variations are contemplated as being within the scope of this disclosure wherein such configurations are only to be limited by the claims.

In an example, a biasing member (two biasing members 28a, 28b are shown in the drawings, e.g., FIG. 4) is provided between the mounting arms 14a, 14b and the handle 22a, 22b. For example, the biasing members 28a, 28b may be springs connected on one end to a mounting portion 30a, 30b of the mounting bracket 12, and on the other end of the springs to the mounting arm 14a, 14b. The biasing members 28a, 28b bias (e.g., a spring-bias) the mounting arm 14a, 14b (and thereby also bias the handle 22a, 22b) so that the handle 22a, 22b is in the first index position 24a by default, so that the handle 22a, 22b has to be pulled against the biasing force toward the index positions 24b, 24c to raise the mounting arm 14a, 14b and hence the wheel 26a, 26b into a raise position. That is, moving the handle away from the second end 18a, 18b of the mounting arm 14a, 14b (e.g., from the first index position 24a toward index positions 24b, or 24c) is against a force of the biasing member 28a, 28b. In this way, the biasing member 28a, 28b applies a down-force on the closing wheel 26a, 26b toward the ground.

It is noted that the biasing member can be any one of an extension spring (e.g., springs 28a, 28b shown in the drawings), a compression spring, a torsion axle, a gas spring, a hydraulic actuator, an air-driven actuator, an electric actuator, a round bumper spring, and/or any other suitable biasing member configured to perform the operations shown and described herein.

In an example, the axis of one of the mounting arms (e.g., mounting arm 14a) is offset forward or behind in orientation to the axis of the other mounting arm (e.g., mounting arm 14b), as seen by way of example in the top view shown in FIG. 4 and the bottom view shown in FIG. 5. In addition, each mounting arm 14a, 14b has a primary angle to aid the corresponding closing wheels 26a, 26b in directing soil into the trench.

In an example, the closing wheel 26a, 26b have an adjustable secondary vertical pitch and horizontal camber adjustment mechanism 32a, 32b selectable to further aid in directing the desired amount of soil over the trench. The adjustment mechanism 32a, 32b may be an adjustable spacer or washer 33 mounted on the axle of the closing wheel 26a, 26b between the closing wheel 26a, 26b and the mounting arm 14a, 14b, as seen for example in FIG. 4. The washer 33 is shown as it may have different size sidewalls (e.g., sidewall 34a is longer in height or spacing from sidewall 34b). Accordingly, the washer 33 can be turned with the sidewall 34a, 34b facing the desired direction on the axle of the closing wheel 26a, 26b to adjust the vertical pitch and horizontal camber of the closing wheel 26a, 26b. Once adjusted to the desired vertical pitch and horizontal camber, the closing wheel 26a, 26b can be tightened on the axle against the mounting arm 14a, 14b to retain the desired vertical pitch and horizontal camber of the closing wheel 26a, 26b.

To illustrate this adjustment for vertical pitch, the longer sidewall 34a of the washer 33 is shown in FIG. 4 at the top of the axle, with the shorter sidewall 34b of the washer 33 (visible in the bottom view of FIG. 5) at the bottom of the axle, thereby offsetting the top of the closing wheel 26a, 26b from a vertical plane that is perpendicular to the axle of the closing wheel 26a, 26b, by a greater distance at the top, and a shorter distance at the bottom of the closing wheel 26a, 26b.

To illustrate this adjustment for horizontal camber, the longer sidewall 34c is shown in FIG. 5 at the front of the axle (toward the bottom of the drawing page), with the shorter sidewall 34d shown in FIG. 5 at the back of the axle (toward the top of the drawing page), thereby offsetting the front of the closing wheel 26a, 26b from the vertical plane (the plane that is perpendicular to the axle of the closing wheel 26a, 26b) by a greater distance at the front, and a shorter distance at the back of the closing wheel 26a, 26b.

In an example operation, the device 10 may be attached to a tractor or other farm equipment, and implemented as an agricultural planter with one or more seed trencher disc 50 (e.g., FIG. 1 and FIG. 2) having a seed delivery mechanism which deposits seeds and/or other product (e.g., fertilizer) in a trench opened by the trencher disc 50. The closing wheel 26a, 26b are mounted rearward of the trencher disc 50 on the adjustable arms 14a, 14b so as to provide a depth gauging function for the trencher disc 50.

In an example, an in-row firming wheel 52 that is spring/torsion loaded and runs in the bottom of the seed trench created by the trench opener disc 50, but before closing wheel 26a, 26b, in order to ensure that the seed is deposited in the bottom of the seed trench and firmed/pressed to the desired amount. This ensures optimal seed to soil contact, and even emergence of sprouted seed for the well-being of each plant. The firming wheel 52 may be rotatably mounted in line with the center of trench opener disc 50 so as to rotatably follow the concentricity of the trench opener disc 50 in its range of travel.

In an example, the closing wheel 26a, 26b are mounted to run at an angle and distance corresponding to the trencher disc 50) so as to move displaced trench soil back over the trench while effectively running at a position where dirt and debris try to lift out of the opening trench due to the action of the trencher disc 50. This allows the closing wheel 26a, 26b to apply pressure in a lift out zone area of dirt and debris to prevent the lift out from occurring. This effectively provides the device 10 with a closing function, which allows the lifted debris and dirt, to enclose the trench if this function is actuated by its operator.

The closing wheel(s) 26a, 26b includes an array of fingers 27, each of short length relative to a radius of the closing wheel 26a, 26b. In an example, each of the array of fingers 27 are curved and cupped. Each of the array of fingers 27 extend forward of an outer rim 25 of the closing wheel 26a, 26b as the closing wheel(s) 26a, 26b roll through a lower forward quadrant. Each of the array of fingers 27 also extend outward of a vertical plane of the closing wheel 26a, 26b.

In an example, the array of fingers 27 around the wheel rim further prevent soil lift out and aid in movement of crop debris and residue through the system while reducing the soil to a fine homogenous soil for an optimal planting condition. Each of the array of fingers 27 are positioned in a way to surround the radius of the closing wheel 26a, 26b. Each finger of the array of fingers 27 is configured to be short in length, relative to the radius of the closing wheel 26a, 26b, and further positioned to extend forward of the outer rim of each closing wheel 26a, 26b. As the closing wheel 26a, 26b rolls forward, through a lower forward quadrant, each of the fingers 27 extends outward from the plane of the closing wheel 26a, 26b.

The closing wheel 26a, 26b is configured to adjust in a vertical direction by operation of the handle 22a, 22b, resulting in a gauge of a seeder planting depth. Through adjustment of the position of a handle 22a, 22b, vertical height adjustment (e.g., as illustrated by arrows 20) can be made to the closing wheel 26a, 26b, resulting in gauging of desired seeder planting depth. It is noted that the handle 22a, 22b depicted in the drawings is only an example. The handle can be any form of adjustable moving mechanisms, for example, including a screw adjustment, an actuator, a slotted adjustment, etc.

In an example, the closing wheel 26a, 26b is adjustable in a horizontal direction (illustrated by arrows 21) via a horizontal chamber 48a, 48b (seen in FIG. 4 and FIG. 5) formed in the mounting arm 14a, 14b, resulting in an offset (or alignment) of the closing wheels 26a, 26b relative to one another. Although not visible in FIG. 4 and FIG. 5, the axle of the closing wheels 26a, 26b extends through the chamber 48a, 48b and is attached with a nut (also not visible in FIG. 4 and FIG. 5). The closing wheel 26a, 26b is also adjustable in a vertical direction (e.g., illustrated by arrow 20), resulting in an increase or decrease of soil over a seed trench. Vertical adjustment is achieved via the handle 22a, 22b and positioning it to the desired vertical depth orientation based on the index location 24a-c.

In an example, the horizontal adjustment of the closing wheel 26a, 26b can be performed by a bolt hole configuration where one loosens the slotted hole and shifts the wheel configuration within the constraints of the slotted hole.

In an example, the closing wheel 26a, 26b is adjustable in a vertical direction and in a pitch angle relative to a central plane of the closing wheel 26a, 26b, resulting in an increase or decrease of a movement of soil.

In an example, the closing wheel 26a, 26b can be adjusted in pitch and camber relative to a central plane of the closing wheel 26a, 26b. This may be achieved by the angled axle washer 33 that is adjusted relative to the predetermined angled plane, and then the axle bolt is tightened to the bearing of the closing wheel 26a, 26b to adjust pitch and camber as described above.

In an example implemented in combination with any of the above examples, the fingers 27 can also (or instead) be configured to extend inwardly of the plane of the closing wheel 26a, 26b. Based on this positioning, the closing wheel 26a, 26b is configured to move dirt continuously from the outward portion of the closing wheel 26a, 26b, to the inward portion of the closing wheel 26a, 26b in order to fill the seed trench as a row cleaner assembly to move a desired amount of debris and/or soil away from the trench. The wheel 26a, 26b configured as a row cleaner assembly is positioned ahead of the at least one closing wheel and centered to run in a middle and bottom of the trench.

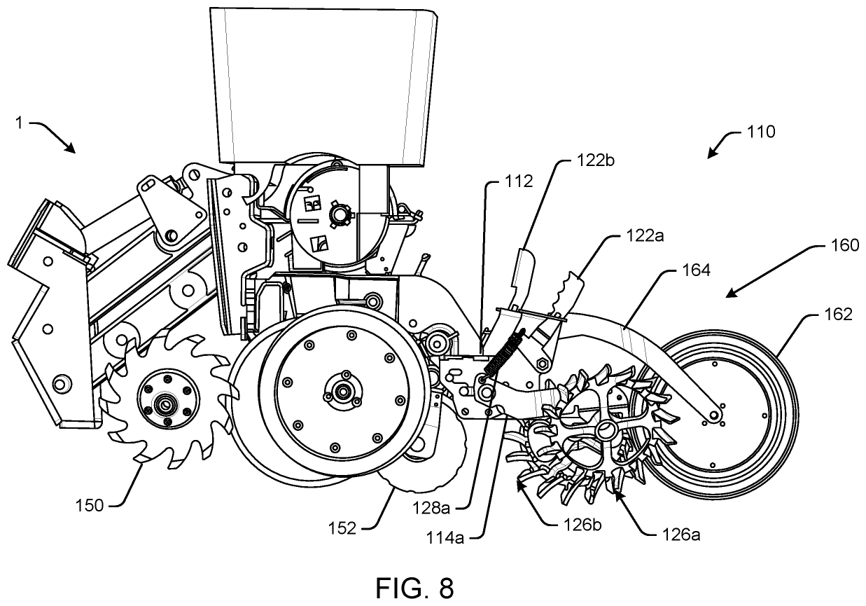

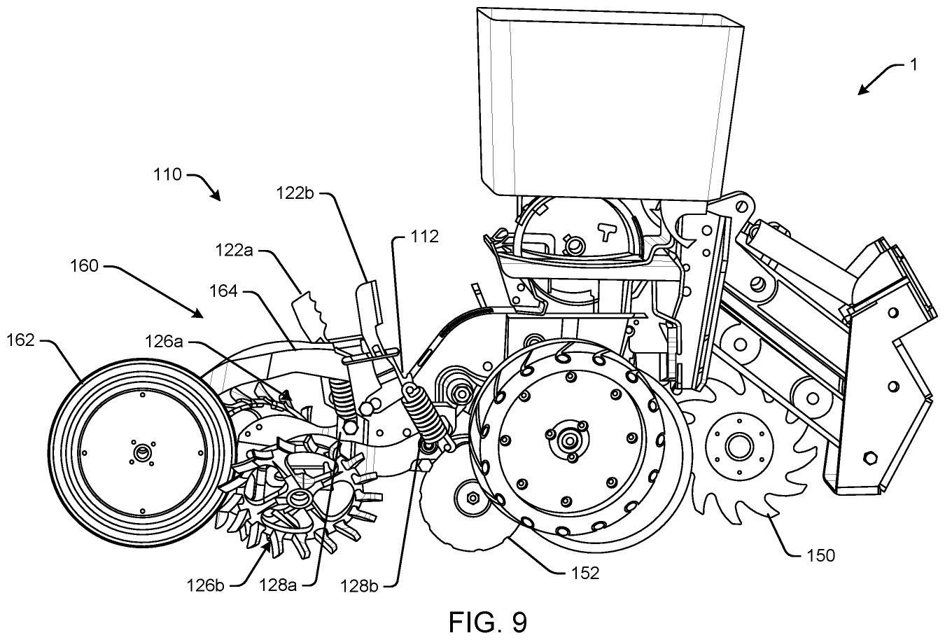

FIG. 8 depicts a right side view of another example of independently functioning closing wheel arms 110 having a third independent wheel assembly 160 on an agricultural row unit closing assembly 1. FIG. 9 depicts a left side view of the example of Independently functioning closing wheel arms 110 with the third independent wheel assembly 160 on an agricultural row unit closing assembly 1, corresponding to FIG. 8. It is noted that 100-series reference numbers are used in FIG. 8 and FIG. 9 corresponding to reference numbers already described above, and may not be described again here for sake of brevity. For example, the independently functioning closing wheel arms 110 shown in FIG. 8 and FIG. 9 correspond to the independently functioning closing wheel arms 10 described above with reference to FIGS. 1-7.

In an example, the independent wheel assembly 160 is positioned behind the closing wheel 126a, 126b and centered to run over the trench after the trench is closed. The independent wheel 162 of the independent wheel assembly 160 can be mounted on an extension arm 164. In an example, the extension arm 164 can be mounted to the mounting frame 112. In another example the extension arm 164 can be connected to one of the handles 122a, 122b to move with the handle 122a, 122b. As such, the independent wheel 162 can be adjusted in height by operation of the handle 122a, 122b with the corresponding one of the closing wheels 126a, 126b.

It is noted that the examples shown and described are provided for purposes of illustration and are not intended to be limiting. Still other examples are also contemplated.

1. A closing assembly for an agricultural row unit to be mounted on a trenching implement, the closing assembly configured for trench closing functions of various seeding, fertilizer, soil amendments, and soil working purposes, comprising:
a mounting frame for attaching to the agricultural row unit of the trenching implement;
at least one mounting arm having a first end connected to pivot about a mounting axis on the mounting frame, the at least one mounting arm having a second end movable to different heights in response to pivotable movement of the first end;
a handle operatively associated with the at least one mounting arm, the handle moveable between at least two separate positions, each of the at least two separate positions corresponding to the different heights of the second end of the at least one mounting arm; and
at least one closing wheel rotatably mounted on the second end of the at least one mounting arm so that the at least one closing wheel moves with the second end of the at least one mounting arm between each of the different heights.

2. The closing assembly of claim 1, further comprising two mounting arms, each having a separate closing wheel rotatably mounted thereon.

3. The closing assembly of claim 2, further comprising two handles for each of the two mounting arms, wherein the handles are operable to independently move each of the two mounting arms.

4. The closing assembly of claim 1, further comprising a plurality of indexing positions on the mounting frame, each of the indexing positions configured to retain the handle at a predetermined one of the at least two separate positions.

5. The closing assembly of claim 4, further comprising at least three separate indexing positions for the handle, each of the three separate indexing positions corresponding to three different heights for the at least one closing wheel.

6. The closing assembly of claim 1, further comprising a biasing member between the at least one mounting arm and the handle, the at least one biasing member biasing the handle toward the second end of the at least one mounting arm, and wherein moving the handle away from the second end of the at least one mounting arm is against a force of the biasing member.

7. The closing assembly of claim 6, wherein the biasing member is at least one of an extension spring, a compression spring, a torsion axle, a gas spring, a hydraulic actuator, an air-driven actuator, an electric actuator, and a round bumper spring.

8. The closing assembly of claim 6, wherein the biasing member applies a down-force on the at least one closing wheel toward the ground.

9. The closing assembly of claim 1, further comprising a plurality of closing wheels and a corresponding plurality of mounting arms, wherein each axis of each mounting arm is offset forward or behind in orientation to the axis of the other mounting arm, each of the plurality of closing wheels configured to direct soil into a trench

10. The closing assembly of claim 9, wherein, each mounting arm has a primary angle to aid a corresponding one of the plurality of closing wheels in directing soil into the trench.

11. The closing assembly of claim 9, wherein each of the plurality of closing wheels has an adjustable secondary vertical pitch and horizontal camber adjustment mechanism selectable to further aid in directing the desired amount of soil over the trench.

12. The closing assembly of claim 1, further comprising an adjustable furrow firming wheel to press seed or product to the bottom of the trench.

13. The closing assembly of claim 12, wherein the furrow firming wheel is positioned ahead of the at least one closing wheel and centered to run in a middle and bottom of the trench.

14. The closing assembly of claim 1, further comprising a row cleaner assembly configured to move a desired amount of debris and/or soil away from the trench.

15. The closing assembly of claim 14, wherein the row cleaner assembly is positioned ahead of the at least one closing wheel and centered to run in a middle and bottom of the trench.

16. The closing assembly of claim 1, further comprising an independent wheel assembly positioned behind the at least one closing wheel and centered to run over the trench after the trench is closed.

17. The closing assembly of claim 16, wherein the independent wheel assembly is mounted on an extension arm connected to the mounting frame.

18. The closing assembly of claim 16, wherein the independent wheel assembly is mounted on an extension arm and is adjustable in height along with the at least one closing wheel by operation of the handle.

19. A closing assembly for an agricultural row unit to be mounted on a trenching implement, the closing assembly configured for trench closing functions of various seeding, fertilizer, soil amendments, and soil working purposes, comprising:
a mounting frame for attaching to the agricultural row unit of the trenching implement;
at least one mounting arm having a first end connected to pivot about a mounting axis on the mounting frame, the at least one mounting arm having a second end movable to different heights in response to pivotable movement of the first end;
an adjustment device operatively associated with the at least one mounting arm, the adjustment device moveable between at least two separate positions, each of the at least two separate positions corresponding to the different heights of the second end of the at least one mounting arm; and
at least one closing wheel rotatably mounted on the second end of the at least one mounting arm so that the at least one closing wheel moves with the second end of the at least one mounting arm between each of the different heights.

20. The closing assembly of claim 19, wherein adjustment device is one of an electric actuator, hydraulic or air cylinder, and air bag.
